(19) United States
(12) Patent Application Publication
(10) Pub. No.: US 2007/0123602 A1
(43) Pub. Date: May 31, 2007

(54) Use of thermal reversible associations for enhanced polymer interactions

(75) Inventors: Jeffrey Linhardt, Fairport, NY (US); Joseph C. Salamone, Boca Raton, FL (US); Daniel M. Ammon JR., Penfield, NY (US); Roya N. Borazjani, Forth Worth, TX (US)

Correspondence Address: Bausch & Lomb Incorporated, One Bausch & Lomb Place, Rochester, NY, 14604-2701, US

(73) Assignee: Bausch & Lomb Incorporated

(21) Appl. No.: 11/595,385

(22) Filed: Nov. 9, 2006

Related U.S. Application Data
(60) Provisional application No. 60/740,534, filed on Nov. 29, 2005.

(51) Int. Cl. G02B 1/04

(52) U.S. Cl. 523/106

(57) ABSTRACT

The present invention relates generally to the development of medical devices which show thermal reversible associations with similar polymer molecules contained in the majority of device care solutions. The thermal reversible association provides an enhanced interaction which leads to less bacterial adhesion and uptake on the device and sustained release of a conditioning agent.

### PRIORITY CLAIM

This application claims the benefit of Provisional Patent Application No. 60/740,534 filed Nov. 29, 2005 and is incorporated herein by reference.

### FIELD

The present invention relates generally to the development of medical devices which show thermal reversible associations with similar polymer molecules contained in the majority of device care solutions. The thermal reversible association provides an enhanced interaction which leads to less bacterial adhesion and uptake on the device and sustained release of a conditioning agent.

### BACKGROUND

Poloxamer block copolymers are known compounds and are generally available under the trademark PLURONIC. Poloxamers have the following general formula:
HO(C₂H₄O)ₐ(C₃H₆O)_{b}(C₂H₄O)ₐH

Reverse poloxamers are also known block copolymers and have the following general formula:
HO(C₃H₆O)_{b}(C₂H₄O)ₐ(C₃H₆O)_{b}H
wherein a and b are of varying lengths.

Poloxamers and reverse poloxamers have end terminal hydroxyl groups that can be functionalized. An example of an end terminal functionalized poloxamer is poloxamer dimethacrylate (Pluronic F-127 dimethacrylate) as disclosed in US Patent Publication No. 2003/0044468 to Cellesi et al. U.S. Pat. No. 6,517,933 discloses glycidyl-terminated copolymers of polyethylene glycol and polypropylene glycol.

Poloxamers and reverse poloxamers are surfactants with varying HLB values based upon the varying values of a and b, a representing the number of hydrophilic poly(ethylene oxide) units (PEO) being present in the molecule and b representing the number of hydrophobic poly(propylene oxide) units (PPO) being present in the molecule. While poloxamers and reverse poloxamers are considered to be difunctional molecules (based on the terminal hydroxyl groups) they are also available in a tetrafunctional form known as poloxamines, trade name TETRONIC. For poloxamines, the molecules are tetrafunctional block copolymers terminating in primary hydroxyl groups and linked by a central diamine. Poloxamines have the following general structure:

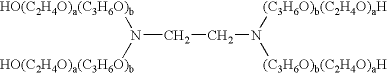

Reverse poloxamines are also known and have varying HLB values based upon the relative ratios of a to b.

Medical devices such as ophthalmic lenses can generally be subdivided into two major classes, namely hydrogels and non-hydrogels. Non-hydrogels do not absorb appreciable amounts of water, whereas hydrogels can absorb and retain water in an equilibrium state.

Hydrogels are widely used as soft contact lens materials. It is known that increasing the hydrophilicity of the contact lens surface improves the wettability of the contact lenses. This in turn is associated with improved wear comfort of contact lenses. Additionally, the surface of the lens can affect the overall susceptibility of the lens to deposition of proteins and lipids from the tear fluid during lens wear. Accumulated deposits can cause eye discomfort or even inflammation. In the case of extended wear lenses (i.e. lenses used without daily removal of the lens before sleep), the surface is especially important, since extended wear lenses must be designed for high standards of comfort and biocompatibility over an extended period of time. Thus new devices that have the potential to yield improved surface qualities are still desirable in this field of art.

### BRIEF DESCRIPTION OF THE DRAWINGS

FIG. 1 is a graphical representation of the results of Example 3;

FIG. 2 is a graphical representation of the results of Example 4.

### DETAILED DESCRIPTION

As utilized herein the expression “reversible thermal association” refers to the properties of some polymers to undergo abrupt changes in solubility in response to increased temperature. This change in solubility favors polymer-polymer interactions rather than polymer-solvent interactions.

Polyethers that are present at the surface of substrates have long been known to inhibit bacterial adhesion and to reduce the amount of lipid and protein deposition (non-fouling surface). In the present invention, we take advantage of the property of thermal reversible association/hydrophobic association of polymers in solution and similar molecules comprising a medical device. Examples would include chemically modified poloxamer and poloxamine block copolymers (BASF Corp.) included in medical device forming formulations or on the surface of medical devices.

The present invention relates generally to development of new prototypes of conventional hydrogel contact lenses that show improved and enhanced properties. In preferred embodiments the present invention relates to a lens which shows enhanced interactions with similar polymer molecules contained in the majority of lens care solutions. The enhanced interaction leads to less bacterial adhesion and uptake and sustained release of conditioning agent.

Examples of biomaterials useful in the present invention are taught in U.S. Pat. Nos. 5,908,906 to Kunzler et al.; 5,714,557 to Kunzler et al.; 5,710,302 to Kunzler et al.; 5,708,094 to Lai et al.; 5,616,757 to Bambury et al.; 5,610,252 to Bambury et al.; 5,512,205 to Lai; 5,449,729 to Lai; 5,387,662 to Kunzler et al. and 5,310,779 to Lai; which patents are incorporated by reference as if set forth at length herein.

Rigid gas-permeable (RGP) materials typically comprise a hydrophobic cross-linked polymer system containing less than 5 wt. % water. RGP materials useful in accordance with the present invention include those materials taught in U.S. Pat. Nos. 4,826,936 to Ellis; 4,463,149 to Ellis; 4,604,479 to Ellis; 4,686,267 to Ellis et al.; 4,826,936 to Ellis; 4,996,275 to Ellis et al.; 5,032,658 to Baron et al.; 5,070,215 to Bambury et al.; 5,177,165 to Valint et al.; 5,177,168 to Baron et al.; 5,219,965 to Valint et al.; 5,336,797 to McGee and Valint; 5,358,995 to Lai et al.; 5,364,918 to Valint et al.; 5,610,252 to Bambury et al.; 5,708,094 to Lai et al. and 5,981,669 to Valint et al. U.S. Pat. No. 5,346,976 to Ellis et al. teaches a preferred method of making an RGP material.

The invention is applicable to a wide variety of polymeric materials, either rigid or soft. Especially preferred polymeric materials are lenses including contact lenses, phakic and aphakic intraocular lenses and corneal implants although all polymeric materials including biomaterials are contemplated as being within the scope of this invention. Hydrogels comprise hydrated, crosslinked polymeric systems containing water in an equilibrium state. Such hydrogels could be silicone hydrogels, which generally have water content greater than about five weight percent and more commonly between about ten to about eighty weight percent. Such materials are usually prepared by polymerizing a mixture containing at least one siloxane-containing monomer and at least one hydrophilic monomer. Applicable siloxane-containing monomeric units for use in the formation of silicone hydrogels are well known in the art and numerous examples are provided in U.S. Pat. Nos. 4,136,250; 4,153,641; 4,740,533; 5,034,461; 5,070,215; 5,260,000; 5,310,779; and 5,358,995. Moreover, the use of siloxane-containing monomers having certain fluorinated side groups, i.e. —(CF₂)—H, have been found to improve compatibility between the hydrophilic and siloxane-containing monomeric units, as described in U.S. Pat. Nos. 5,387,662 and 5,321,108.

The poloxamer and/or poloxamine may be functionalized to provide the desired reactivity at the end terminal of the molecule. The functionality can be varied and is determined based upon the intended use of the functionalized PEO- and PPO-containing block copolymers. That is, the PEO- and PPO-containing block copolymers are reacted to provide end terminal functionality that is complementary with the intended device forming monomer mixture. By block copolymer we mean to define the poloxamer and/or poloxamine as having two or more blocks in their polymeric backbone(s).

Selection of the functional end group is determined by the functional group of the reactive molecule in the monomer mix or polymerized device. For example, if the reactive molecule contains a carboxylic acid group, glycidyl methacrylate can provide a methacrylate end group. If the reactive molecule contains hydroxy or amino functionality, isocyanato ethyl methacrylate or (meth)acryloyl chloride can provide a methacrylate end group and vinyl chloro formate can provide a vinyl end group. A wide variety of suitable combinations of ethylenically unsaturated end groups and reactive molecules will be apparent to those of ordinary skill in the art. For example, the functional group may comprise a moiety selected from amine, hydrazine, hydrazide, thiol (nucleophilic groups), carboxylic acid, carboxylic ester, including imide ester, orthoester, carbonate, isocyanate, isothiocyanate, aldehyde, ketone, thione, alkenyl, acrylate, methacrylate, acrylamide, sulfone, maleimide, disulfide, iodo, epoxy, sulfonate, thiosulfonate, silane, alkoxysilane, halosilane, and phosphoramidate. More specific examples of these groups include succinimidyl ester or carbonate, imidazolyl ester or carbonate, benzotriazole ester or carbonate, p-nitrophenyl carbonate, vinyl sulfone, chloroethylsulfone, vinylpyridine, pyridyl disulfide, iodoacetamide, glyoxal, dione, mesylate, tosylate, and tresylate. Also included are other activated carboxylic acid derivatives, as well as hydrates or protected derivatives of any of the above moieties (e.g. aldehyde hydrate, hemiacetal, acetal, ketone hydrate, hemiketal, ketal, thioketal, thioacetal). Preferred electrophilic groups include succinimidyl carbonate, succinimidyl ester, maleimide, benzotriazole carbonate, glycidyl ether, imidazoyl ester, p-nitrophenyl carbonate, acrylate, tresylate, aldehyde, and orthopyridyl disulfide.

The foregoing reaction sequences are intended to be illustrative, not limiting. Examples of reaction sequences by which PEO- and PPO-containing block copolymers can be end-functionalized are provided below:

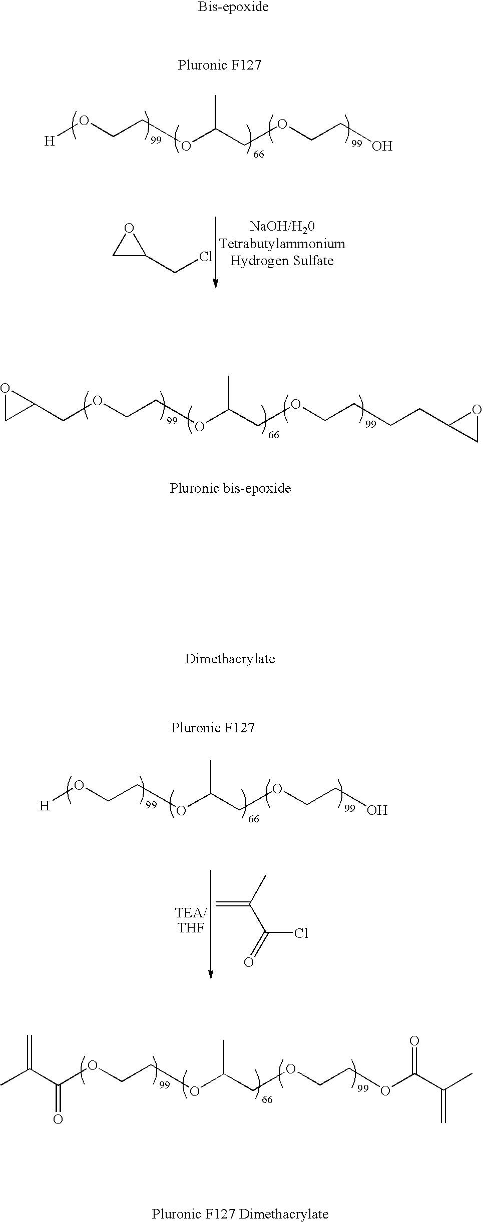

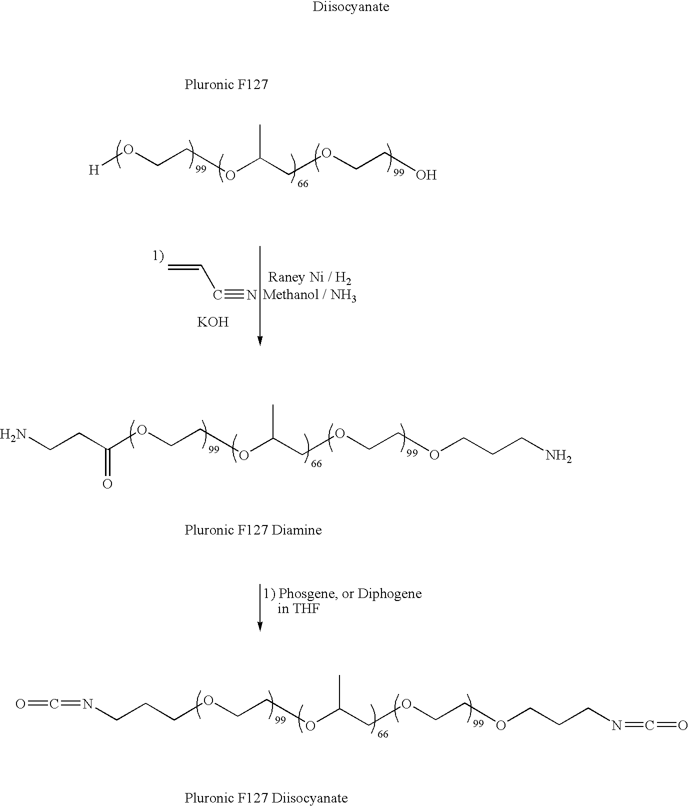

Further provided herein are certain exemplary, but non-limiting, examples of reactions for providing functionalized termini for PEO- and PPO-containing block copolymers. It is to be understood that one of ordinary skill in the art would be able to determine other reaction methods without engaging in an undue amount of experimentation. It should also be understood that any particular block copolymer molecule shown is only one chain length of a polydispersed population of the referenced material.

Although PEO- and PPO-containing block copolymers are presently preferred as components capable of forming a thermal reversible association with a similar component in a solution, other components capable of such associations are also known. For example, E. Ruel-Gariepy and J C Leroux in Eur. J. Pharma and Biopharma 58, (2004), pp 409-426, describe a number of insitu-forming hydrogels in temperature-sensitive systems. Such components capable of thermal reversible association include, for example, polysaccharides, proteins, polysaccharide derivatives, protein derivatives, N-isopropylacrylamide copolymers, poly(ethylene oxide)/(D,L-lactic acid -co-glycolic acid) copolymers and thermosensitive liposome-based systems.

Device Forming Additives and Comonomers

The polymerizable composition may, further as necessary and within limits not to impair the purpose and effect of the present invention, contain various additives such as antioxidant, coloring agent, ultraviolet absorber and lubricant.

In the present invention, the polymerizable composition may be prepared by using, according to the end-use and the like of the resulting shaped polymer articles, one or at least two of the above comonomers and oligomers and functionalized surfactants: and, when occasions demand, one or more crosslinking agents.

Where the shaped polymer articles are for example medical products, in particular a contact lens, the polymerizable composition is suitably prepared from one or more of the silicon compounds, e.g. siloxanyl (meth)acrylate, siloxanyl (meth)acrylamide and silicone oligomers, to obtain contact lenses with high oxygen permeability.

The monomer mix of the present invention may include additional components such as crosslinking agents, internal wetting agents, hydrophilic monomeric units, toughening agents, and other components as is well known in the art.

Although not required, compositions within the scope of the present invention may include toughening agents, preferably in quantities of less than about 80 weight percent e.g. from about 5 to about 80 weight percent, and more typically from about 20 to about 60 weight percent. Examples of suitable toughening agents are described in U.S. Pat. No. 4,327,203. These agents include cycloalkyl acrylates or methacrylates, such as: methyl acrylate and methacrylate, t-butylcyclohexyl methacrylate, isopropylcyclopentyl acrylate, t-pentylcyclo-heptyl methacrylate, t-butylcyclohexyl acrylate, isohexylcyclopentyl acrylate and methylisopentyl cyclooctyl acrylate. Additional examples of suitable toughening agents are described in U.S. Pat. No. 4,355,147. This reference describes polycyclic acrylates or methacrylates such as: isobornyl acrylate and methacrylate, dicyclopentadienyl acrylate and methacrylate, adamantyl acrylate and methacrylate, and isopinocamphyl acrylate and methacrylate. Further examples of toughening agents are provided in U.S. Pat. No. 5,270,418. This reference describes branched alkyl hydroxyl cycloalkyl acrylates, methacrylates, acrylamides and methacrylamides. Representative examples include: 4-t-butyl-2-hydroxycyclohexyl methacrylate (TBE); 4-t-butyl-2-hydroxycyclopentyl methacrylate; methacryloxyamino-4-t-butyl-2-hydroxycyclohexane; 6-isopentyl-3-hydroxycyclohexyl methacrylate; and methacryloxyamino-2-isohexyl-5-hydroxycyclopentane.

Internal wetting agents may also be used for increasing the wettability of such hydrogel compositions. Examples of suitable internal wetting agents include N-alkyenoyl trialkylsilyl aminates as described in U.S. Pat. No. 4,652,622. These agents can be represented by the general formula:
CH₂═C(E)C(O)N(H)CH(G)(CH₂)qC(O)OSi(V)₃
wherein:

E is hydrogen or methyl,

G is (CH₂)ᵣC(O)OSi(V)₃ or hydrogen,

V is methyl, ethyl or propyl,

q is an integer form 1 to 15,

r is an integer form 1 to 10,

q+r is an integer form 1 to 15, hereinafter referred to as NATA.

Acryloxy- and methacryloxy-, mono- and dicarboxylic amino acids, hereinafter NAA, impart desirable surface wetting characteristics to polysiloxane polymers, but precipitate out of monomer mixtures that do not contain siloxane monomers before polymerization is completed. NAA can be modified to form trialkylsilyl esters which are more readily incorporated into polysiloxane polymers. The preferred NATAs are trimethylsilyl-N-methacryloxyglutamate, triethylsilyl-N-methacryloxyglutamate, trimethyl-N-methacryloxy-6-aminohexanoate, trimethylsilyl-N-methacryloxy-aminododecanoate, and bis-trimethyl-silyl-N-methacryloxyaspartate.

Preferred wetting agents also include acrylic and methacylic acids, and derivatives thereof. Typically, such wetting agents comprise less than 5 weight percent of the composition.

Other preferred internal wetting agents include oxazolones as described in U.S. Pat. No. 4,810,764 to Friends et al. issued Mar. 7, 1989, the contents of which are incorporated by reference herein. These preferred internal wetting agents specifically include 2-isopropenyl-4,4-dimethyl-2-oxazolin-5-one (IPDMO), 2-vinyl-4,4-dimethyl-2-oxazolin-5-one (VDMO), cyclohexane spiro-4′-(2′isopropenyl-2′-oxazol-5′-one) (IPCO), cyclohexane-spiro-4′-(2′-vinyl-2′-oxazol-5′-one) (VCO), and 2-(-1-propenyl)-4,4-dimethyl-oxazol-5-one (PDMO). The preparation of such oxazolones is known in the art and is described in U.S. Pat. No. 4,810,764.

These preferred internal wetting agents have two important features which make them particularly desirable wetting agents: (1) they are relatively non-polar and are compatible with the hydrophobic monomers (the polysiloxanes and the toughening agents), and (2) they are converted to highly polar amino acids on mild hydrolysis, which impart substantial wetting characteristics. When polymerized in the presence of the other components, a copolymer is formed. These internal wetting agents polymerize through the carbon-carbon double bond with the endcaps of the polysiloxane monomers, and with the toughening agents to form copolymeric materials particularly useful in biomedical devices, especially contact lenses.

As indicated, the subject hydrogel compositions includes hydrophilic monomeric units. Examples of appropriate hydrophilic monomeric units include those described in U.S. Pat. Nos. 4,259,467; 4,260,725; 4,440,918; 4,910,277; 4,954,587; 4,990,582; 5,010,141; 5,079,319; 5,310,779; 5,321,108; 5,358,995; 5,387,662; all of which are incorporated herein by reference. Examples of preferred hydrophilic monomers include both acrylic- and vinyl-containing monomers such as hydrophilic acrylic-, methacrylic-, itaconic-, styryl-, acrylamido-, methacrylamido- and vinyl-containing monomers

Preferred hydrophilic monomers may be either acrylic- or vinyl-containing. Such hydrophilic monomers may themselves be used as crosslinking agents. The term “vinyl-type” or “vinyl-containing” monomers refers to monomers containing the vinyl grouping (CH₂ ═CQH), and are generally highly reactive. Such hydrophilic vinyl-containing monomers are known to polymerize relatively easily. “Acrylic-type” or “acrylic-containing” monomers are those monomers containing the acrylic group represented by the formula:

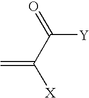

wherein X is preferably hydrogen or methyl and Y is preferably —O—, —OQ—, —NH—, —NQ— and —NH(Q)—, wherein Q is typically an alkyl or substituted alkyl group. Such monomers are known to polymerize readily.

Preferred hydrophilic vinyl-containing monomers which may be incorporated into the hydrogels of the present invention include monomers such as N-vinyllactams (e.g. N-vinylpyrrolidone (NVP)), N-vinyl-N-methylacetamide, N-vinyl-N-ethylacetamide, N-vinyl-N-ethylformamide, N-vinylformamide, with NVP being the most preferred.

Preferred hydrophilic acrylic-containing monomers which may be incorporated into the hydrogel of the present invention include hydrophilic monomers such as N,N-dimethylacrylamide (DMA), 2-hydroxyethyl methacrylate, glycerol methacrylate, 2-hydroxyethyl methacrylamide, methacrylic acid and acrylic acid, with DMA being the most preferred.

Suitable ethylenically unsaturated hydrophilic monomers include ethylenically unsaturated polyoxyalkylenes, polyacrylamides, polyvinylpyrrolidones, polyvinyl alcohols, poly(hydroxyethyl methacrylate) or poly (HEMA), and N-alkyl-N-vinylacetamides. Ethylenic unsaturation may be provided by (meth)acrylate, (meth)acrylamide, styrenyl, alkenyl, vinyl carbonate and vinyl carbamate groups. Preferred hydrophilic macromonomers include methoxypolyoxyethylene methacrylates of molecular weights from 200 to 10,000, more preferred are methoxypolyoxyethylene methacrylates of molecular weight range of 200 to 5,000 and most preferred are methoxypolyoxyethylene methacrylates of molecular weight range of 400 to 5,000. Additional preferred hydrophilic macromonomers include poly(N-vinylpyrrolidone) methacrylates of molecular weights of 500 to 10,000. More preferred are poly(N-vinylpyrrolidone methacrylates) of molecular weights of 500 to 5,000 and most preferred are poly(N-vinylpyrrolidone) methacrylates of molecular weights of 1000 to 5,000. Other preferred hydrophilic macromonomers include poly(N,N-dimethyl acrylamide methacrylates) of molecular weights of 500 to 10,000. More preferred are poly(N,N-dimethylacrylamide methacrylates) of molecular weights of 500 to 5,000 and most preferred are poly(N,N-dimethylacrylamide methacrylates) of molecular weights of 1000 to 5,000.

Suitable ethylenically unsaturated hydrophobic monomers include alkyl (meth)acrylates, N-alkyl (meth)acrylamides, alkyl vinylcarbonates, alkyl vinylcarbamates, fluoroalkyl (meth)acrylates, N-fluoroalkyl (meth)acrylamides, N-fluoroalkyl vinylcarbonates, N-fluoroalkyl vinylcarbamates, silicone-containing (meth)acrylates, (meth)acrylamides, vinyl carbonates, vinyl carbamates, styrenic monomers [selected from the group consisting of styrene, α-methyl styrene, ρ-methyl styrene, ρ-t-butylmonochlorostyrene, and ρ-t-butyldichlorostyrene] and poly[oxypropylene (meth)acrylates]. Preferred hydrophobic monomers include methyl methacrylate, dodecyl methacrylate, octafluoropentyl methacrylate, hexafluoroisopropyl methacrylate, perfluorooctyl methacrylate, methacryoyloxypropyltris(trimethylsiloxy)silane (TRIS).

When both an acrylic-containing monomer and a vinyl-containing monomer are incorporated into the invention, a further crosslinking agent having both a vinyl and an acrylic polymerizable group may be used, such as the crosslinkers which are the subject of U.S. Pat. No. 5,310,779, issued May 10, 1994, the entire content of which is incorporated by reference herein. Such crosslinkers help to render the resulting copolymer totally UV-curable. However, the copolymer could also be cured solely by heating, or with a combined UV and heat regimen. Photo and/or thermal initiators required to cure the copolymer will be included in the monomer mix, as is well-known to those skilled in the art. Other crosslinking agents which may be incorporated into the silicone-containing hydrogel including those previously described. Other techniques for increasing the wettability of compositions may also be used within the scope of the present invention, e.g. plasma surface treatment techniques which are well known in the art.

Particularly preferred hydrogel compositions comprise from about 0.1 to about 50 weight percent of functionalized poloxamers and/or poloxamines, from about 0.1 to about 30 weight percent of functionalized poloxamers and/or poloxamines, and from about 0.1 to about 4.9% weight percent of functionalized poloxamers and/or poloxamines. An advantage of using less than 5% of functionalized poloxamers and/or poloxamines is that the optical transmission of the device tends to decrease at higher concentrations of functionalized poloxamers and/or poloxamines.

The monomer mixes employed in this invention can be readily cured to desired shapes by conventional methods such as UV polymerization, or thermal polymerization, or combinations thereof, as commonly used in polymerizing ethylenically unsaturated compounds. Representative free radical thermal polymerization initiators are organic peroxides, such as acetyl peroxide, lauroyl peroxide, decanoyl peroxide, stearoyl peroxide, benzoyl peroxide. t-butyl peroxypivalate, peroxydicarbonate, and the like, employed in a concentration of about 0.01 to 1 percent by weight of the total monomer mixture. Representative UV initiators are those known in the field such as, benzoin methyl ether, benzoin ethyl ether, DAROCUR 1173, 1164, 2273, 1116, 2959, 3331 (EM Industries) and IGRACUR 651 and 184 (Ciba-Geigy).

Polymerization of the end-functionalized poloxamers and/or poloxamines with other comonomers is generally performed (with crosslinking agents) in the presence of a diluent. The polymerization product will then be in the form of a gel. If the diluent is nonaqueous, the diluent may be removed from the gel and replaced with water through the use of extraction and hydration protocols well known to those of ordinary skill in the art. It is also possible to perform the polymerization in the absence of diluent to produce a xerogel. These xerogels may then be hydrated to form the hydrogels as is well known in the art.

In addition to the above-mentioned polymerization initiators, the copolymer of the present invention may also include other monomers as will be apparent to one of ordinary skill in the art. For example, the monomer mix may include colorants, or UV-absorbing agents such as those known in the contact lens art.

The present invention provides medical devices such as heart valves and intraocular lenses, films, surgical devices, heart valves, vessel substitutes, intrauterine devices, membranes and other films, diaphragms, surgical implants, blood vessels, artificial ureters, artificial breast tissue and membranes intended to come into contact with body fluid outside of the body, e.g., membranes for kidney dialysis and heart/lung machines and the like, catheters, mouth guards, denture liners, ophthalmic devices, and especially contact lenses.

The polymers of this invention can be formed into ophthalmic devices by spincasting processes (such as those disclosed in U.S. Pat. Nos. 3,408,429 and 3,496,254), cast molding, lathe cutting, or any other known method for making the devices. Polymerization may be conducted either in a spinning mold, or a stationary mold corresponding to a desired shape. The ophthalmic device may be further subjected to mechanical finishing, as occasion demands. Polymerization may also be conducted in an appropriate mold or vessel to form buttons, plates or rods, which may then be processed (e.g., cut or polished via lathe or laser) to give an ophthalmic device having a desired shape.

When used in the formation of hydrogel (soft) contact lenses, it is preferred that the subject hydrogels have water contents of from about 20 to about 90 weight percent. Furthermore, it is preferred that such hydrogels have a modulus from about 20 g/mm² to about 150 g/mm², and more preferably from about 30 g/mm² to about 100 g/mm².

In order for the thermal reversible association between a component that comprises the medical device and a further component that comprises the solution to occur, the device is brought into contact with a solution containing like components as those that comprise the device. These like components typically comprise device care solutions such as cleaning and/or storage solutions. More specifically contact lens care solutions.

Therefore, solution components capable of forming thermal reversible association suitable for use in the present invention may also be useful as a component of a cleaning, disinfecting or conditioning solution and/or composition. Such solutions and/or compositions also may include, antimicrobial agents, surfactants, toxicity adjusting agents, buffers and the like that are known to be used components of conditioning and/or cleaning solutions for contact lenses. Examples of suitable formulations for cleaning and/or disinfecting solutions are taught in U.S. Pat. No. 5,858,937 to Richard et al., which is incorporated by reference as if set forth at length herein. Preferably, compositions and/or solutions of the present invention may be formulated as a “multi-purpose solution,” meaning that such compositions and/or solutions may be used for cleaning, chemical disinfection, storing, and rinsing a contact lens. A multi-purpose solution preferably has a viscosity of less than 75 cps, preferably 1 to 50 cps, and most preferably 1 to 25 cps and is preferably is at least 95 percent weight by volume water in the total composition.

Surfactants, which are suitable for use in the present invention, are classified into cationic surfactants, anionic surfactants, nonionic surfactants and ampholytic surfactants depending upon their dissociation state in their aqueous solutions. Among them, various surfactants which are classified into cationic surfactants, particularly surfactants which consist of an amino acid derivative, i.e. amino acid type cationic surfactants have conventionally been proposed as disinfectant cleaning agents or compositions for disinfection. Amphoteric surfactants suitable for use in a composition according to the present invention include materials of the type are offered commercially under the trade name “MIRANOL.” Another useful class of amphoteric surfactants is exemplified by cocoamidopropyl betaine, commercially available from various sources.

Various other surfactants suitable for use in the composition can be readily ascertained, in view of the foregoing description, from McCutcheon's Detergents and Emulsifiers, North American Edition, McCutcheon Division, MC Publishing Co., Glen Rock, N.J. 07452 and the CTFA International Cosmetic Ingredient Handbook, Published by The Cosmetic, Toiletry, and Fragrance Association, Washington, D.C.

One specific class of surfactants are PLURONICS and reverse PLURONICS which are a series of ABA and BAB type block copolymers, respectively. The ABA block copolymers are composed of poly(ethylene oxide)-poly(propylene oxide)-poly(ethylene oxide) moieties, and the BAB block copolymers are composed of poly(propylene oxide)-poly(ethylene oxide)-poly(propylene oxide) blocks. The poly(ethylene oxide), PEO, blocks are hydrophilic, whereas poly(propylene oxide), PPO, blocks are hydrophobic in nature. Such materials are commercially available under the trade name PLUORONIC. The poloxamers are derived from different ratios of PEO and PPO. Another specific class of surfactants is the poloxamines, available under the trade name Tetronic, which contain blocks of PEO and PPO connected by an ethylenediamine moiety.

Optionally, one or more additional polymeric or non-polymeric demulcents may be combined with the above-named ingredients. Demulcents are known to provide wetting, moisturizing and/or lubricating effects, resulting in increased comfort. Polymeric demulcents can also act as a water-soluble viscosity builder. Included among the water-soluble viscosity builders are the non-ionic cellulosic polymers like methyl cellulose, hydroxyethyl cellulose, hydroxypropyl cellulose, and carboxymethyl cellulose, poly(N-vinylpyrrolidone), poly(vinylalcohol) and the like. Such viscosity builders or demulcents may be employed in a total amount ranging from about 0.01 to about 5.0 weight percent or less. Suitably, the viscosity of the final formulation is 10 cps to 50 cps. Comfort agents such as glycerin or propylene glycol can also be added.

As an illustration of the present invention, several examples are provided below. These examples serve only to further illustrate certain aspects of the invention and should not be construed as limiting the invention.

### EXAMPLES

### Example 1

### Synthesis of Functionalized Surfactants

6.00 g of PLURONIC F127 was placed in a round bottom flask and dried thoroughly via azeotropic distillation of toluene (100 ml). The round bottom flask was then fitted with a reflux condenser and the reaction was blanketed with Nitrogen gas. Anhydrous tetrahydrofuran (THF) (60 ml) was added to the flask and the reaction was chilled to 5° C. with 15 equivalents (based upon the hydroxyl endgroups) of triethylamine (TEA)was added (2.0 ml). 1.4 ml of methacryoyl chloride (15 equivalents) was dropped into the reaction mixture through an addition funnel and the reaction mixture was allowed to warm to room temperature and then stirred overnight. The reaction mixture was then heated to 65° C. for 3 hours. Precipitated salt (TEA-HCl) was filtered from the reaction mixture and the filtrate was concentrated to a volume of around 355 mL and precipitated into cold heptane. Two further reprecipitations were performed to reduce the amount of TEA-HCl salt to less than 0.2% by weight. NMR analysis of the final polymer showed greater than 90% conversion of the hydroxyl endgroups to the methacrylated endgroups.

### Example 2

### Synthesis of Surfactant Epoxides

10.00 gms of PLURONIC F38 (2.13E-03 mol) are placed in a round bottom flask and dried thoroughly via azeotropic distillation of toluene and then dissolved in 100 mL of THF. 10 equivalents of solid NaH were added into the flask (0.51 gm; 2.13E-02 mol). Next 1.67 mL of epichlorohydrin (2.13E-03 mol) was added to the reaction mixture and mixed well and the reaction mixture was heated to reflux for 24 hours. The reaction mixture was cooled and a scoop of magnesium sulfate and silica gel was added to remove any water. Mixed well for 5 minutes and then filtered off the insolubles. Filtrate was concentrated to around 30 mL final volume and the product was precipitated into heptane and isolated by filtration. NMR confirms the presence of epoxide groups on the termini of the polymer.

### Example 3

### Sustained Release of Pluronics (Conditioning Agent) as Determined by NMR

HWCL (High Water Content Lens) Formulations

| Formu- | NVP/ | | Allyl | | |
|---|---|---|---|---|---|
| lation | TBE mix | EGDMA | Methacrylate | AIBN | F127-DM |
| 1 | 99 | 0.25 | 0.25 | 0.5 | 0 |
| 2 | 94 | 0.25 | 0.25 | 0.5 | 5 |
| 3 | 89 | 0.25 | 0.25 | 0.5 | 10 |

*NOTE:
NVP/TBE mix consists of 90 parts NVP and 10 parts of TBE

Contact lenses made from formulations 1 and 2 were used in the NMR study of sustained release of Pluronic F-38.

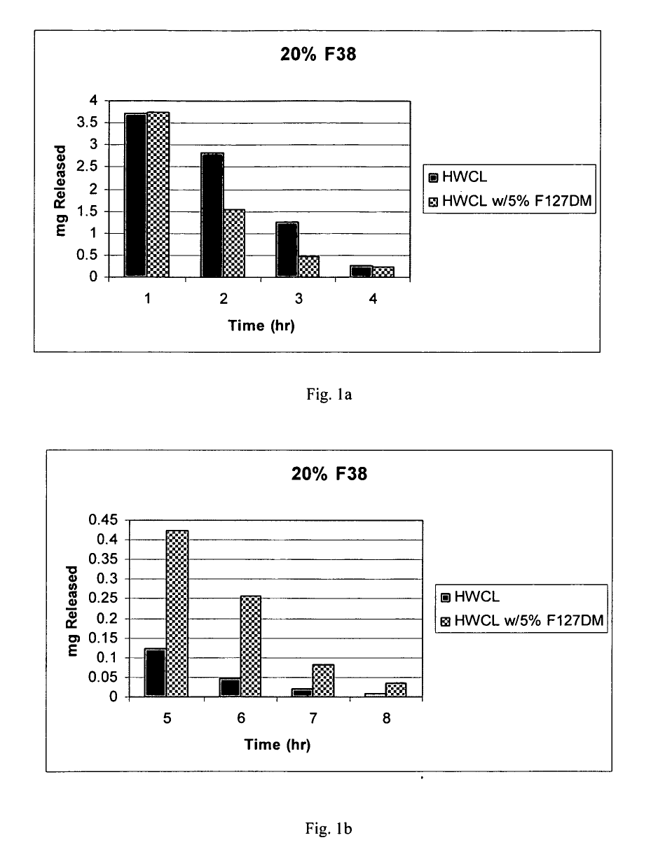

Lenses made from formulation 1 and Formulation 2 were soaked overnight in a 20% weight Pluronic F38 solution in D₂O. At the initiation of the experiment, lenses were removed from this soaking solution and placed on the basket of a contact lens holder. D₂O was flushed in a controlled manner over the contact lens utilizing a syringe pump and a flow rate of 1 mL of D₂O per hour. The solution that was flushed over the lens was collected and proton NMR spectra were obtained to determine the concentration of Pluronic-F38. The results of this experiment are shown in FIG. 1.

As can be seen from FIG. 1, the lenses made from Formulation 2 in the table (which contains 5% by weight of Pluronic F127-dimethacrylate) released Pluronic F38 at a slower initial rate and for a longer period of time than the unmodified lenses made from Formulation 1. At the 2 and 3 hour time points a higher concentration of Pluronic F38 is being released from the unmodified lenses than from the modified lenses which is indicative that the Pluronic is not as tightly associated. In addition, when looking at the data points at longer times (5, 6, 7, and 8 hours) more Pluronic F38 is being released from formulation 2 than from 1 indicating that the Pluronic surfactant is released over a longer time period. The crossover at around 4 hours occurs because the unmodified lens is being depleted of the Pluronic F38 due to weaker association.

### Example 4

### Antimicrobial Study of Pluronics Associated with Contact Lenses

HWCL (High Water Content Lens) Formulations

| Formu- | NVP/ | | Allyl | | |
|---|---|---|---|---|---|
| lation | TBE mix | EGDMA | Methacrylate | AIBN | F127-DM |
| 1 | 99 | 0.25 | 0.25 | 0.5 | 0 |
| 2 | 94 | 0.25 | 0.25 | 0.5 | 5 |
| 3 | 89 | 0.25 | 0.25 | 0.5 | 10 |

*NOTE:
NVP/TBE mix consists of 90 parts NVP and 10 parts of TBE

Contact lenses made from the following formulations were used in microbial attachment study of lenses soaked in Pluronic F127.

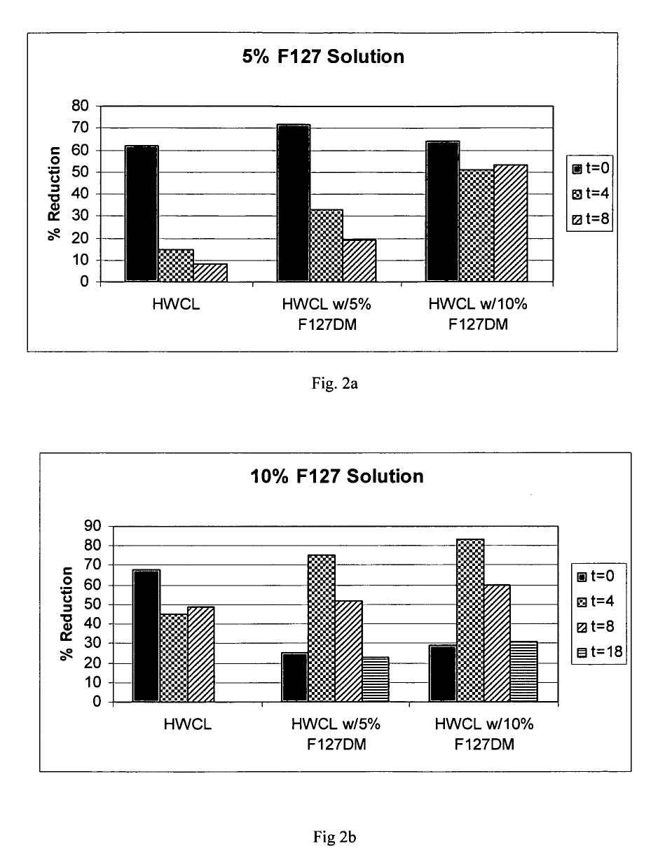

Contact lenses of formulations 1, 2, and 3 were soaked in either 5% or 10% Pluronic F127 in phosphate buffered saline. The lenses were removed from this solution and tested for primary attachment of Pseudomonas aeruginosa at time=0 (not rinsed) and after 4 hours, 8 hours, and 18-24 hours of rinsing in PBS buffer. The results of this study showing the percent reduction in Pseudomonas attachment are shown in FIG. 2. When contact lenses are soaked in 5% F127 solution (FIG. 2a), the percent of bacterial reduction is increased at the 4 and 8 hour time points for lenses with 5% and 10% Pluronic F127 dimethacrylate, respectively. This is indicative of enhanced interactions between the Pluronic in solution and the Pluronic copolymerized in the lens matrix. When contact lenses are soaked in the 10% F127 solution (FIG. 2b), the lenses from formulation 2 and 3 also show that the percent of bacterial reduction is increased at longer time points (8 and 18-24 hours). This again shows that the lenses containing F127 dimethacrylate as a comonomer retain the Pluronics in solution longer.

The above examples are intended to illustrate but not limit certain embodiments of the invention as described in the claims attached hereto. For example, other comonomers that can be added to the polymerizable surfactant comonomer mixtures would be obvious to one of skill in the art. Also, as additional ophthalmic devices are developed it would be expected that polymerizable surfactants will also be useful in other ophthalmic devices.

What is claimed is:

1. A device comprising:
a polymerized comonomer mixture comprising at least one component capable of forming a thermal reversible association with a similar component in a solution; and
a component of the solution that is thermal reversible associated with the medical device.

2. The device of claim 1 wherein the device is a contact lens.

3. The device of claim 2 wherein the contact lens is a rigid gas permeable contact lens.

4. The device of claim 2 wherein the lens is a soft contact lens.

5. The device of claim 2 wherein the lens is a hydrogel contact lens.

6. The device of claim 1 wherein the lens is an intraocular lens.

7. The device of claim 6 wherein the lens is a phakic intraocular lens.

8. The device of claim 6 wherein the lens is an aphakic intraocular lens.

9. The device of claim 1 wherein the device is a corneal implant.

10. The device of claim 1 further comprising as part of the comonomer mixture an organo silicon compound.

11. The device of claim 10 wherein the silicon compound is selected from the group consisting of siloxanyl (meth)acrylate, siloxanyl (meth)acrylamide, siloxynyl vinyl carbamate, polymerizable siloxane oligomers and macromonomers and mixtures thereof.

12. The device of claim 10 further comprising as part of the monomer mixture at least one member selected from the group consisting of crosslinking agents, internal wetting agents, hydrophilic monomers and toughening agents.

13. The device of claim 12 wherein the hydrophilic monomers are selected from the group consisting of hydrophilic acrylic-, methacrylic-, itaconic-, styrenyl-, acrylamido-, methacrylamido- and vinyl-containing monomers and mixtures thereof.

14. The device of claim 13 wherein the hydrophilic monomers are selected from the group consisting of monomers containing the acrylic group represented by the formula: 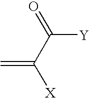
wherein X is hydrogen or methyl and Y is —O—, —OQ—, —NH—, —NQ— and —NH(Q)—, and Q is an alkyl or substituted alkyl group; and mixtures thereof.

15. The device of claim 13 wherein the vinyl-containing hydrophilic monomers are selected from the group consisting of N-vinyllactams, N-vinylpyrrolidone, N-vinyl-N-methylacetamide, N-vinyl-N-ethylacetamide, N-vinyl-N-ethylformamide, N-vinylformamide, and mixtures thereof.

16. The device of claim 13 wherein the hydrophilic monomers are selected from the group consisting of as N,N-dimethylacrylamide, 2-hydroxyethyl methacrylate, glycerol methacrylate, 2-hydroxyethyl methacrylamide, methacrylic acid, acrylic acid and mixtures thereof.

17. The device of claim 1 further comprising as part of the comonomer mixture an ethylenically unsaturated hydrophilic monomer selected from the group consisting of ethylenically unsaturated polyoxyalkylenes, ethylenically unsaturated polyacrylamides, ethylenically unsaturated polyvinylpyrrolidones, ethylenically unsaturated polyvinyl alcohols, ethylenically unsaturated poly(hydroxyethyl methacrylate), ethylenically unsaturated N-alkyl-N-vinyl acetamides and mixtures thereof.

18. The device of claim 17 wherein the ethylenic unsaturation is provided by a group selected from (meth)acrylate, (meth)acrylamide, styrenyl, alkenyl, vinyl carbonate, vinyl carbamate groups and mixtures thereof.

19. The device of claim 1 further comprising hydrophobic monomers.

20. The device of claim 19 wherein the hydrophobic monomer is selected from the group consisting of alkyl (meth)acrylates, N-alkyl (meth)acrylamides, alkyl vinylcarbonates, alkyl vinylcarbamates, fluoroalkyl (meth)acrylates, N-fluoroalkyl (meth)acrylamides, N-fluoroalkyl vinylcarbonates, N-fluoroalkyl vinylcarbamates, silicone-containing (meth)acrylates, (meth)acrylamides, vinyl carbonates, vinyl carbamates, styrenic monomers such as styrene, alpha-methyl styrene, ρ-methyl styrene, ρ-t-butyl monochloro styrene, and ρ-t-butyl dichloro styrene; polyoxypropylene (meth)acrylates, methyl methacrylate, dodecyl methacrylate, octafluoropentyl methacrylate, perfluorooctyl methacrylate, methacryoyl oxypropyl tris(trimethylsiloxy)silane (TRIS) and mixtures thereof.

21. The device of claim 1 further comprising a free radical thermal polymerization initiators selected from the group consisting of organic peroxides such as acetyl peroxide, lauroyl peroxide, decanoyl peroxide, stearoyl peroxide, benzoyl peroxide, t-butyl peroxypivalate, peroxydicarbonate and mixtures thereof.

22. The device of claim 1 further comprising a UV initiator.

23. The device of claim 1 wherein the constituent capable of forming thermal reversible associations is selected from the group consisting of block copolymers of PPO and PEO, polysaccharides, proteins, polysaccharide derivatives, protein derivatives, N-isopropylacrylamide copolymers, poly(ethylene oxide)/(D,L-lactic acid-co-glycolic acid) copolymers, thermosensitive liposome-based systems and mixtures thereof.

24. The device of claim 1 wherein the solution is selected from the group consisting of solutions that may be used for cleaning, chemical disinfection, storing and rinsing a device.

25. The device of claim 1 wherein the device is selected from the group consisting of heart valves, intraocular lenses, films, surgical devices, vessel substitutes, intrauterine devices, membranes, films, diaphragms, surgical implants, blood vessels, artificial ureters, artificial breast tissue, membranes for kidney dialysis machines, membranes for heart/lung machines, catheters, mouth guards, denture liners, ophthalmic devices, and contact lenses.
